(19) United States
(12) Patent Application Publication
(10) Pub. No.: US 2010/0048211 A1
(43) Pub. Date: Feb. 25, 2010

(54) METHOD, DEVICE AND SYSTEM FOR ACQUIRING SPECIFIC ZONE INFORMATION

(75) Inventor: Xiuhong Zhu, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/483,803

(22) Filed: Jun. 12, 2009

(30) Foreign Application Priority Data
Aug. 25, 2008 (CN) 200810146827.8

(51) Int. Cl. H04W 36/00; H04M 1/00

(52) U.S. Cl. 455/436; 455/558

(57) ABSTRACT

A method, a device, and a system for acquiring specific zone information are provided. The method includes: commanding a mobile station to send a request, in which the request is adapted to notify a network side to identify whether a current cell of the mobile station belongs to preset specific zone; and receiving a response returned according to the request by the network side, in which the response includes information about whether the current cell of the mobile station belongs to the preset specific zone identified by the network side. The device includes an active command unit and a receiving unit. Thus, a subscriber can know whether the current location belongs to specific zone without any operation, unnecessary system load is reduced, and an end-to-end experience is provided for the subscriber.

### CROSS-REFERENCE TO RELATED APPLICATIONS

This application claims priority to Chinese Patent Application No. 200810146827.8, filed Aug. 25, 2008, which is hereby incorporated by reference in its entirety.

### FIELD OF THE TECHNOLOGY

The present invention relates to the communication technology field, and more particularly to a method, device, and system for acquiring specific zone information.

### BACKGROUND

Competition in a market becomes more and more fierce. To improve the competitiveness, telecommunication operators not only have to exploit market and increase their market shares by providing various value-added services and new services and improving quality of service, but also have to reduce operating cost, especially control the defaulting subscribers. Therefore, a solution called “online charging system (OCS)” has been developed. The OCS solution may lower the risk of defaulting, effectively control the defaulting, and promotes development of charging systems.

In the OCS solution, an operator defines some cells as a zone, and provides preferential charging policies for the zone. A subscriber may set a plurality of zones as a home zone of a mobile station thereof through interactive voice response (IVR). The home zone is a specific zone of the mobile station preset by the subscriber. If the subscriber selects the zones as home zone of the mobile station thereof, the subscriber can enjoy corresponding preferential charging policies of the home zone when calling in the home zone.

If the subscriber desires to know whether current location belongs to the home zone, the subscriber needs to query through the IVR. Specifically, the subscriber dials an IVR access code to trigger a mobile switching center (MSC); the MSC triggers the call to the OCS; the OCS performs an authentication, obtains the cell where the current location of the subscriber is according to an initial detect point (IDP) signaling reported by the MSC, and judges whether the cell included in the home zone set by the subscriber. After the judging, the OCS instructs the MSC to play announcement (PA) to announce the judging result about the current location of the subscriber, in other words, to inform whether the subscriber is located in the set home zone.

In the conventional technology, the mobile station cannot automatically know whether the current location belongs to the home zone. Specifically, the subscriber does not know the coverage area of each of the home zone; when the location of the subscriber changes, the subscriber does not know whether the current location belongs to the home zone set by the subscriber. Therefore, in order to know whether the current location belongs to the home zone so as to know whether a preferential tariff may be applied, the subscriber needs to dial the IVR access code for query each time when the location changes. For the subscriber, additional operations are required, which are quite inconvenient. Further, as the subscriber needs to dial the IVR access code frequently, unnecessary load is added to the system. Moreover, since whether the current location of the subscriber belongs to the home zone cannot be judged automatically, no end-to-end experience is provided for the subscriber.

### SUMMARY

Accordingly, embodiments of the present invention provide a method, device, and system for acquiring specific zone information, so as to solve the problem that a mobile station cannot automatically know whether a current location belong to specific zone.

A method for acquiring specific zone information is provided, which includes the following: (1) a mobile station is commanded to send a request, in which the request is adapted to notify a network side to identify whether a current cell of the mobile station belongs to a preset specific zone; and (2) a response returned according to the request by the network side is received, in which the response includes information about whether the current cell of the mobile station belongs to the preset specific zone identified by the network side.

A method for acquiring specific zone information is provided, and the method includes the following: (1) a mobile station is commanded to send a request, in which the request is adapted to notify a network side to identify whether a current cell of the mobile station belongs to a preset specific zone; (2) a response returned according to the request by the network side is received, in which the response includes information about whether the current cell of the mobile station belongs to the preset specific zone identified by the network side; and (3) the mobile station is commanded to display the information about whether the current cell belongs to the preset specific zone included in the response.

A method for identifying specific zone is provided, and the method includes the following: (1) a request from a mobile station is received, in which the request is adapted to identify whether a current cell of the mobile station belongs to a preset specific zone; (2) whether the current cell of the mobile station belongs to the preset specific zone is identified; and (3) a response is returned to the mobile station, in which the response includes identified information about whether the current cell of the mobile station belongs to the preset specific zone.

A mobile station is provided, and the mobile station includes: (1) an active command unit, adapted to command the mobile station to send a request, in which the request is adapted to notify a network side to identify whether a current cell of the mobile station belongs to a preset specific zone; and (2) a receiving unit, adapted to receive a response returned according to the request by the network side, in which the response includes information about whether the current cell of the mobile station belongs to the preset specific zone identified by the network side.

A subscriber identity module (SIM) card for acquiring specific zone information is provided, and the SIM card includes: (1) an analysis unit, adapted to analyze whether a mobile station satisfies conditions for sending a request to a network side currently, in which the request is adapted to notify the network side to identify whether a current cell of the mobile station belongs to a preset specific zone; and (2) a command unit, adapted to command the mobile station to send the request to the network side when the analysis unit analyzes that the mobile station satisfies the conditions for sending the request to the network side currently.

A system for acquiring specific zone information is provided, and the system includes: a mobile station, adapted to communicate with the network side, send a request for notifying the network side to identify whether a current cell of the mobile station belongs to a preset specific zone to the network side, and receive a response returned according to the request by the network side, wherein the response includes information about whether the current cell of the mobile station belongs to the preset specific zone identified by the network.

It can be inferred that since the SIM of the mobile station can command the mobile station to actively send the request for identifying whether the current location belongs to the preset specific zone, the subscriber may know whether the current location belongs to the preset cells without any operation. Moreover, since the subscriber does not need to dial the IVR access code, the system load is reduced, and an end-to-end experience is provided for the subscriber.

### BRIEF DESCRIPTION OF THE DRAWINGS

FIG. 1 is a flow chart of a method for acquiring specific zone information according to an embodiment of the present invention;

FIG. 2 is a flow chart of the method of the present invention according to a specific embodiment;

FIG. 3 is a flow chart of a method for acquiring and displaying specific zone information according to an embodiment of the present invention; and

FIG. 4 is a structural view of a mobile station of a device according to an embodiment of the present invention.

### DETAILED DESCRIPTION

In order to make the foregoing features and advantages of the present invention more comprehensible, the present invention is described in detail below through specific embodiments.

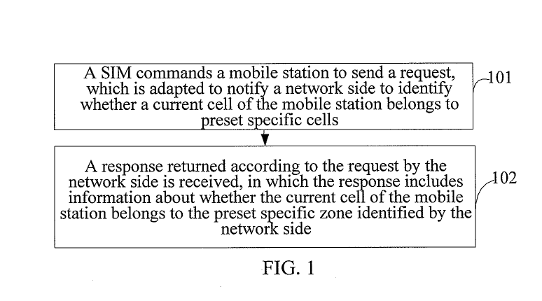

FIG. 1 is a flow chart of a method for acquiring specific zone information according to an embodiment of the present invention. Referring to FIG. 1, the method includes the following steps.

Step 101: A SIM commands a mobile station to send a request, in which the request is adapted to notify a network side to identify whether a current cell of the mobile station belongs to a preset specific zone.

Step 102: A response returned according to the request by the network side is received, in which the response includes information about whether the current cell of the mobile station belongs to the preset specific zone identified by the network side.

The steps shown in FIG. 1 are described in detail below through specific embodiments. In the specific embodiments, the network side is specifically an online charging system (OCS), and the specific zone is specifically a home zone.

In this embodiment, the SIM of the mobile station commands the mobile station to send an unstructured supplementary services data (USSD) request in the following two manners. The first manner is as follows: the SIM of the mobile station detects whether the location of the mobile station changes; if it is detected that the location of the mobile station has changed, judges whether the mobile station performs a cell handover and commands the mobile station to send the USSD request to the OCS if the mobile station performs the cell handover. For the second manner, the SIM of the mobile station periodically commands the mobile station to send the USSD request to the OCS. The specific embodiments are described by taking the first mode as an example.

The OCS judges whether the current location of the mobile station belongs to the home zone set by the subscriber according to the received USSD request. After the judging, the OCS returns a USSD response to the mobile station.

The details are as follows. The SIM has a SIM Application Toolkit (SAT or STK) function. The STK is also referred to as an application program development packet, and is an extended function provided by Global System for Mobile Communication (GSM) Phase II. The STK function makes the mobile station provide not only various services and applications of the GSM, but also special services and applications according to requirements of subscribers (generally, mobile operators) by presetting related programs in the SIM, thereby achieving a function of customizing services according the requirements of the subscribers. In the embodiments of the present invention, through this function, the SIM may initiate an active command to inquire related information of the location of the mobile station, such as the cell that the current location of the mobile station belongs to and received signal intensity, and initiate an active command to command the mobile station to send the USSD request.

In addition, because some mobile stations may not include SIMs, the SIM is one preferred embodiment of the following specific embodiments.

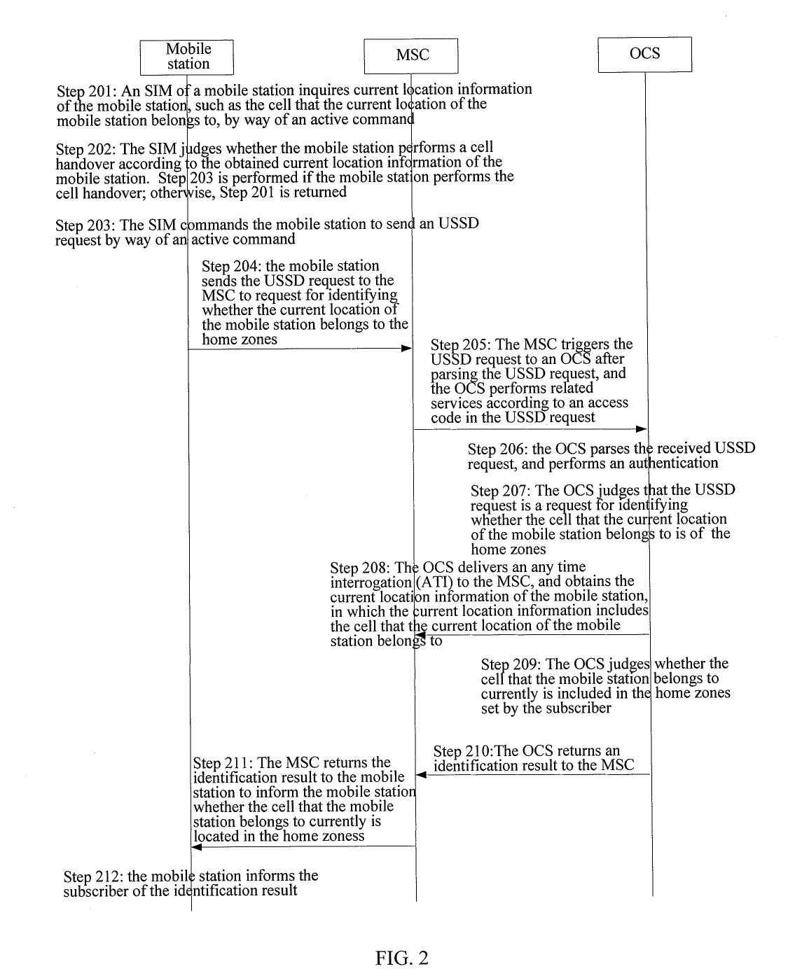

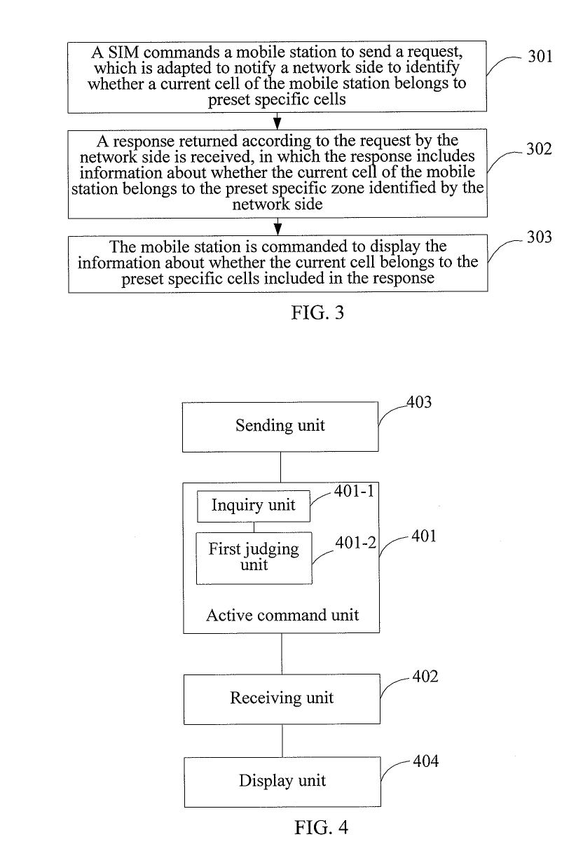

FIG. 2 is a flow chart of the method of the present invention according to a specific embodiment. Referring to FIG. 2, the method may include the following.

Step 201: An SIM of a mobile station inquires current location information of the mobile station, such as the cell that the current location of the mobile station belongs to, by way of an active command.

Step 202: The SIM judges whether the mobile station performs a cell handover according to the obtained current location information of the mobile station. Step 203 is performed if the mobile station performs the cell handover. Otherwise, Step 201 is returned.

If the mobile station does not perform the cell handover, whether the cell that the current location of the mobile station belongs to is included in the preset home zone is the same as the situation before the location of the mobile station changes.

Step 203: The SIM commands the mobile station to send an USSD request by way of an active command.

Step 204: The mobile station sends the USSD request to an MSC to request for identifying whether the current location of the mobile station belongs to the home zone.

Step 205: The MSC triggers the USSD request to an OCS after parsing the USSD request, and the OCS performs related services according to an access code in the USSD request.

Step 206: The OCS parses the received USSD request, and performs an authentication.

Step 207: The OCS judges that the USSD request is a request for identifying whether the cell that the current location of the mobile station belongs to is of the home zone.

Step 208: The OCS delivers an any time interrogation (ATI) to the MSC, and obtains the current location information of the mobile station, in which the current location information includes the cell that the current location of the mobile station belongs to.

The OCS may obtain the current location information of the mobile station not by delivering the ATI, but obtains the current location information of the mobile station (such as a cell ID) according to the received USSD request.

Step 209: The OCS judges whether the cell that the mobile station belongs to currently is included in the home zone set by the subscriber.

Step 210: The OCS returns an identification result to the MSC.

Step 211: The MSC returns the identification result to the mobile station to inform the mobile station whether the cell that the mobile station belongs to currently is located in the home zone.

For example, a check result code may be returned. A 0 indicates that the cell that the mobile station belongs to currently is not included in the home zone, and a 1 indicates that the cell that the mobile station belongs to currently is included in the home zone.

Step 212: The mobile station informs the subscriber of the identification result.

The mobile station may further process the check result code; for example, process the code into voice or other forms to inform the subscriber.

Step 212 may also be implemented in the way that the SIM of the mobile station commands the mobile station to display the identification result on a screen.

It may be seen that since the SIM of the mobile station can actively inquire the current location of the mobile station, identify whether the mobile station performs the cell handover, and command the mobile station to actively send the USSD request to the OCS, and therefore, the subscriber may know whether the current location belongs to the home zone without any operation. Further, the system load is reduced. Moreover, an end-to-end experience is provided for the subscriber since the mobile station can inform the subscriber of the identification result.

Based on Steps 101-102, because the mobile station further needs to display the acquired specific zone information, the present invention also provides a method for acquiring and displaying specific zone information. The method may include the following.

Step 301: A mobile station is commanded to send a request, in which the request is adapted to notify a network side to identify whether a current cell of the mobile station belongs to a preset specific zone.

Step 302: A response returned according to the request by the network side is received, in which the response includes information about whether the current cell of the mobile station belongs to the preset specific zone identified by the network side.

Step 303: The mobile station is commanded to display the information about whether the current cell belongs to the preset specific zone included in the response.

The present invention further provides a mobile station for acquiring specific zone information, and the mobile station includes: (1) an active command unit, adapted to command the mobile station to send a request, in which the request is adapted to notify a network side to identify whether a current cell of the mobile station belongs to a preset specific zone; and (2) a receiving unit, adapted to receive a response returned according to the request by the network side, in which the response includes information about whether the current cell of the mobile station belongs to the preset specific zone identified by the network side.

The mobile station provided in an embodiment of the present invention is described in detail below with reference to the method according to an embodiment of the present invention.

FIG. 4 is a structural view of a mobile station according to a specific embodiment of the present invention.

In FIG. 4, the active command unit may be implemented in two manners. The first manner is as follows: the active command unit includes an inquiry unit 401-1 and a first judging unit 401-2; the inquiry unit is adapted to inquire current location information of the mobile station, and the first judging unit is adapted to judge whether the mobile station performs a cell handover according to the current location information obtained by the inquiry unit; and the active command unit commands the mobile station to send a request for identifying whether the current cell of the mobile station belongs to a preset zone if the mobile station performs the cell handover. In the device according to an embodiment of the present invention, the first manner is taken as an example for description.

The other manner for implementing the active command unit is as follows: the active command unit includes a second judging unit, which is adapted to judge whether a time interval is a preset threshold value; and the active command unit commands the mobile station to send the request if the time interval reaches the preset threshold value.

In addition, in FIG. 4, the mobile station of the device according to an embodiment of the present invention may further include: (1) a sending unit 403, adapted to send a request for identifying whether the current cell is a preset cell; and (2) a display unit 404, adapted to display information about whether the current cell belongs to the preset specific zone included in a response received by the receiving unit. In the device according to an embodiment of the present invention, the mobile station including the display unit is taken as an example for description.

The mobile station may not include the display unit 404, but include a notification unit, which is adapted to notify the subscriber of whether the current cell belongs to the preset zone according to the identification result received by the receiving unit.

In the device according to a specific embodiment of the present invention, the active command unit may be a SIM card. The steps performed among the units, the MSC and the OCS are described as follows.

The inquiry unit of the mobile station inquires current location information of the mobile station, such as the cell that the current location of the mobile station belongs to, by way of an active command. The first judging unit judges whether the mobile station performs a cell handover according to the current location information of the mobile station. If the mobile station performs the cell handover, the SIM commands the mobile station to send a USSD request for identifying whether the cell that the current location of the mobile station belongs to is of the home zone.

The sending unit of the mobile station sends the USSD request to the MSC, and the MSC parses the USSD request and sends the USSD request to the OCS. The OCS parses the received the USSD request, and performs an authentication. After the authentication, the OCS judges that the USSD request is a request for identifying whether the cell that the current location of the mobile station belongs to is of the home zone, and delivers an ATI to the MSC to obtain the current location information of the mobile station, and the current location information includes the cell that the current location of the mobile station belongs to. The OCS judges whether the cell that the current location of the mobile station belongs to is of the home zone according to the current location information of the mobile station, and returns an identification result to the MSC. The MSC returns the identification result to the mobile station to inform the mobile station whether the cell that the current location of the mobile station belongs to is of the home zone.

The receiving unit of the mobile station receives the identification result, and the display unit displays the identification result.

It is known from the above description that if the mobile station performs the cell handover, the SIM of the mobile station can actively command the mobile station to send the USSD request for identifying whether the cell that the current location of the mobile station belongs to is of the home zone. Thus, the subscriber can know whether the current location is in the home zone without any operation. Further, the system load is reduced. Moreover, since the notification unit of the mobile station can notify the subscriber of the identification result, an end-to-end experience is provided for the subscriber.

The present invention further provides a SIM card for acquiring specific zone information, and the SIM card may include: (1) an analysis unit, adapted to analyze whether a mobile station satisfies conditions for sending a request to a network side currently, in which the request is adapted to notify the network side to identify whether a current cell of the mobile station belongs to a preset specific zone; and (2) a command unit, adapted to command the mobile station to send the request to the network side when the analysis unit analyzes that the mobile station satisfies the conditions for sending the request to the network side currently.

Based on the method according to the specific embodiments of the present invention, the analysis unit may be implemented in two manners. The first manner is as follows. The analysis unit may include: (1) an inquiry unit, adapted to inquire current location information of the mobile station; and (2) a first judging unit, adapted to judge whether the mobile station performs a cell handover according to the current location information obtained by the inquiry unit.

If the mobile station performs the cell handover, the command unit commands the mobile station to send the request to the network side.

The second manner is as follows. The analysis unit may include a second judging unit, adapted to judge whether a time interval is a preset threshold value.

If the time interval reaches the preset threshold value, the command unit commands the mobile station to send the request to the network side.

The present invention further provides a system for identifying cells, and the system includes: a mobile station, adapted to communicate with the network side, send a request for notifying the network side to identify whether a current cell of the mobile station belongs to a preset specific zone to the network side, and receive a response returned according to the request by the network side, where the response includes information about whether the current cell of the mobile station belongs to the preset specific zone identified by the network side returned according to the request by the network side.

Based on the method according to the embodiments of the present invention, in the system according to an embodiment of the present invention, the network side is specifically an OCS. In addition to the mobile station and the OCS, the system may further include an MSC, which is adapted to receive a USSD request sent by the mobile station and send the USSD request to the OCS, or is adapted to receive a check result sent by the OCS and send the check result to the mobile station.

The steps performed by the mobile station, the MSC, and the OCS are the same as those performed in the method according to the embodiments of the present invention, and may be known with reference to the description of the method according to the embodiments of the present invention.

Those of ordinary skill in the art should understand that all or a part of the steps of the method according to the embodiments of the present invention may be implemented through hardware related to program instructions. The program may be stored in a computer readable storage medium. When the program is run, the steps of the method according to the embodiments of the present invention are performed. The storage medium may be any medium that is capable of storing program codes, such as a ROM, a RAM, a magnetic disk, and an optical disk.

Though illustration and description of the present disclosure have been given with reference to preferred embodiments thereof, it should be appreciated by persons of ordinary skill in the art that various changes in forms and details can be made without deviation from the spirit and scope of this disclosure, which are defined by the appended claims.

1. A method for acquiring specific zone information, comprising:
commanding a mobile station to send a request, notifying a network side to identify whether a current cell of the mobile station belongs to a preset specific zone; and
receiving a response returned from the network side, the response indicating whether the current cell of the mobile station belongs to the preset specific zone.

2. The method according to claim 1, wherein the commanding the mobile station to send the request comprises:
commanding the mobile station to inquire current location information of the mobile station;
judging whether the mobile station performs a cell handover according to the current location information; and
commanding the mobile station to send the request if the mobile station performs the cell handover.

3. The method according to claim 1, wherein
the request is sent periodically.

4. The method according to claim 1, before receiving the response returned from the network side, the method further comprising:
forwarding the request to the network side through a mobile switch center (MSC).

5. The method according to claim 4, wherein the receiving the response returned from the network side comprises:
receiving the response forwarded through the MSC.

6. The method according to claim 1, after the receiving the response returned from the network side, the method further comprising:
notifying a subscriber of whether the current cell belongs to the preset specific zone.

7. The method according to claim 1, after the receiving the response returned from the network side, the method further comprsing:
commanding the mobile station to display whether the current cell belongs to the preset specific zone indicated by the response.

8. A method for identifying specific zone, comprising:
receiving a request from a mobile station;
identifying whether a current cell of the mobile station belongs to a preset specific zone according to the request; and
returning a response to the mobile station, the response indicating whether the current cell of the mobile station belongs to the preset specific zone.

9. The method according to claim 8, the identifying whether the current cell of the mobile station belongs to the preset specific zone further including:
delivering an any time interrogation (ATI) to a mobile switch center (MSC) to obtain current location information of the mobile station; and
identifying whether the current cell belongs to the preset specific zone according to the current location information.

10. The method according to claim 8, wherein:
a cell identification_(ID) of the mobile station in the request is used to identify whether the current cell of the mobile station belongs to the preset specific zone.

11. A mobile station, comprising:
an active command unit, adapted to command the mobile station to send a request, notifying a network side to identify whether a current cell of the mobile station belongs to a preset specific zone; and
a receiving unit, adapted to receive a response returned from the network side, the response indicating whether the current cell of the mobile station belongs to the preset specific zone.

12. The mobile station according to claim 11, wherein the active command unit comprises:
an inquiry unit, adapted to inquire current location information of the mobile station; and
a first judging unit, adapted to judge whether the mobile station performs a cell handover according to the current location information obtained by the inquiry unit, wherein the active command unit commands the mobile station to send the request if the mobile station performs the cell handover.

13. The mobile station according to claim 11, wherein the active command unit comprises:
a second judging unit, adapted to judge whether a time interval is a preset threshold value, wherein the active command unit commands the mobile station to send the request if the time interval reaches the preset threshold value.

14. The mobile station according to claim 11, further comprising:
a sending unit, adapted to send the request to a mobile switching center (MSC).

15. The mobile station according to claim 11, further comprising:
a notification unit, adapted to notify a subscriber whether the current cell belongs to the preset specific zone according to the response received by the receiving unit.

16. The mobile station according to claim 11, further comprising:
a display unit, adapted to display whether the current cell belongs to the preset specific zone indicated by the response.

17. The mobile station according to claim 11, wherein the active command unit includes a subscriber identity module (SIM).

18. A subscriber identity module (SIM) card for acquiring specific zone information, comprising:
an analysis unit, adapted to determine whether a mobile station satisfies conditions for sending a request to a network side for notifying the network side to identify whether a current cell of the mobile station belongs to a preset specific zone; and
a command unit, adapted to command the mobile station to send the request to the network side when the analysis unit determines that the mobile station satisfies the conditions for sending the request to the network side.

19. The SIM card according to claim 18, wherein the analysis unit comprises:
an inquiry unit, adapted to inquire current location information of the mobile station; and
a first judging unit, adapted to judge whether the mobile station performs a cell handover according to the current location information wherein the command unit commands the mobile station to send the request to the network side if the first judge unit judges that the mobile station performs the cell handover.

20. The SIM card according to claim 18, wherein the analysis unit comprises:
a second judging unit, adapted to judge whether a time interval is a preset threshold value, wherein the command unit commands the mobile station to send the request to the network side if the second judging unit judges that the time interval reaches the preset threshold value.
